(19) United States
(12) Patent Application Publication
(10) Pub. No.: US 2002/0134619 A1
(43) Pub. Date: Sep. 26, 2002

(54) Ladder stabilizing apparatus

(76) Inventor: Donald R. Schwenke, Sylmar, CA (US)

Correspondence Address: ROBERT J. SCHAAP, 21241 Ventura Boulevard, Suite 188, Woodland Hills, CA, 91364, US

(21) Appl. No.: 09/815,795

(22) Filed: Mar. 23, 2001

(51) Int. Cl. E06C 7/42

(52) U.S. Cl. 182/107

(57) ABSTRACT

A ladder stabilizing apparatus for holding a ladder in a fixed position against a building structure. The ladder stabilizing apparatus includes a frame having arms adapted to engage and rest upon an upwardly presented surface of a building structure. The position of the arms relative to the ladder held by the stabilizing apparatus is adjustable, such that they can extend outwardly or be retracted inwardly with respect to the position of the ladder. Further, the angle of the frame relative to the ladder can be adjusted so as to engage the eave or the rake of a roof which is other than a flat roof. A substantial downward force, which may have a horizontal force vector no greater then the downward force, is applied to the building, and particularly the roof of the building using a lateral force is applied to the ladder while using the stabilizing apparatus of the invention. A pair of adjustably positionable brackets are mounted on the frame and are sized to engage and extend around each of the side rails of the ladder.

### BACKGROUND OF THE INVENTION

1. Field of the Invention

This invention relates in general to certain new and useful improvements in ladder stabilizing apparatus and more particularly, to an improved ladder stabilizing apparatus which is adjustably positionable so as to obtain an optimum stabilizing position and is also adjustably positionable to removably receive a ladder.

2. Brief Description of Related Art

Ladders are frequently used in a variety of occupations such as roofing occupations, construction work, television antenna installation and the like. There are frequent needs for a homeowner to even use a ladder for access to a roof structure of a house or other building for a variety of maintenance or repair purposes.

Presently, and while there have been several proposals for prior art ladder stabilizing apparatus, there is no effective apparatus which will stabilize a ladder against a lateral shifting movement or tipping movement in an arcuate path away from the building itself. As would be anticipated, there is a large number of accidents, sometimes resulting in vary substantial injury and death occurring from parties using ladders and where the ladder either slips from the building, tips arcuately away from the building or shifts laterally with respect to the building. As a result, those individuals who frequently use ladders also encounter higher insurance premiums because of the potential for injury.

There are various governmental requirements for ladder manufacturers and ladder users which are designed to improve safety and reduce possibilities of accidents and injuries arising from the slippage of a ladder or falling of f a ladder. One of these requirements is to adhere the top of the ladder to a portion of the roof of the building. Typically, this involves the tying of the ladder with a rope to some fixed structure on the building. However, the rope itself presents a hazard in that the party using the ladder can literally trip over the rope if he or she is not careful, thereby resulting in severe accidents, particularly if that party should fall off of the roof.

There are a large number of ladder stabilizing apparatus of various types which have been proposed for holding a ladder relative to a building structure in order to preclude any slidable movement of the ladder or tipping of the ladder which could thereby not only damage the ladder, and perhaps the building structure, but cause serious injury to a user thereof. Most of the prior art ladder stabilizing apparatus usually rely upon some means to physically secure the ladder to a side wall of a building and hence, they are complex, time consuming and difficult to use.

Representative of prior art used for securing a ladder to a side wall of a building is U.S. Pat. No. 2,903,086, to Chubbs, for ladder attachment. The Chubbs patent includes an attachment which has an appearance somewhat similar to the device of the instant application, as hereinafter described. However, Chubbs relies upon an elongate bar or frame having a pair of outwardly extending arms which engage a side wall of a building. In effect, the forces applied to the building are almost all horizontal in nature. Contrariwise, the device of the present invention, as hereinafter described, applies a substantial vertical force so as to actually stabilize the apparatus against the building and on the building.

There are other U.S. patents which also teach of securing a ladder to a side wall of a building. Representative of one of these systems is U.S. Pat. No. 3,713,510 to O'Dell. This apparatus requires securement to the wall of the building before it can actually be used and therefore, suffers the disadvantages mentioned above.

There are several ladder stabilizing apparatus which have arms which are designed to engage a vertically disposed wall of the building and thereby attempt to preclude lateral displacement of the ladder. Representative of this type of structure is U.S. Pat. No. 5,113,973 to Southern. However, it can be observed that this type of device does not actually preclude a lateral shifting movement of the ladder and has no means whatsoever to preclude a tipping of the ladder away from the building.

Other ladder stabilizing apparatus employ some means for engaging a roof structure or otherwise, a portion of a building having a generally upwardly presented surface. However, and here again, these apparatus do not actually secure the ladder. Representative of this type of stabilizing apparatus is U.S. Pat. No. 5,180,032 to Hidalgo and U.S. Pat. No. 4,949,810 to Dwinell. In each of these references, there is nothing to physically hold the ladder to the building itself.

Accordingly, there has been a need for a ladder stabilizing apparatus which will stabilize a ladder with respect to a building structure against a lateral shifting movement to the side or a tipping movement in a arcuate path away from the building.

### OBJECTS OF THE INVENTION

It is, therefore, one of the primary objects of the present invention to provide a ladder stabilizing apparatus which prevents sidewise lateral movement of a ladder with respect to a building structure and an arcuate tipping movement of a ladder away from the building structure.

It is another object of the present invention to provide a ladder stabilizing apparatus of the type stated which provides for adjustable engagement of a ladder in order to accommodate different sizes and types of ladders.

It is a further object of the present invention to provide a ladder stabilizing apparatus of the type stated which includes adjustably positionable arms in order to engage a generally upwardly presented surface of a portion of a roof structure on a building.

It is an additional object of the present invention to provide a ladder stabilizing apparatus of the type stated which can be folded up and stored in a small compact area.

It is also an object of the prevent invention to provide a ladder stabilizing apparatus of the type stated which applies a substantial downward force vector to a roof by a pair of spaced-apart arms extending from a frame secured to the ladder, and essentially with only a small horizontal force applied to the building to thereby firmly stabilize a ladder.

It is another salient object of the present invention to provide a ladder stabilizing apparatus of the type stated which can be manufactured at a relatively low cost and which is highly safe and reliable in operation.

With the above and other objects in view, my invention resides in the novel features of form, construction, arrangement and combination of parts presently described and pointed out in the claims.

### BRIEF SUMMARY OF THE INVENTION

The present invention relates to a ladder stabilizing apparatus which is adapted to stabilize a ladder with respect to a building structure against sidewise lateral movement and to also stabilize the ladder with respect to an arcuate tipping movement away from the building structure. The ladder stabilizing apparatus of the present invention is also adjustable in various ways in order to conform to the size or shape of a generally upwardly presented portion of a roof on a building structure, or otherwise to accommodate ladders of differing sizes.

The ladder stabilizing apparatus of the present invention, at least in general terms, comprises a main frame. A means for releasably coupling the frame to the side rails of a ladder is also provided, and this holds the frame to the ladder. The frame is further provided with a pair of laterally spaced apart arms adapted to extend outwardly from the frame and engage the generally upwardly presented surface on the building structure. In addition, means is provided on the frame for adjustably positioning the arms relative to the ladder in order to obtain a desired amount of stabilization relative to the building structure and the angle of the ladder relative to the building structure.

A pair of brackets also extend outwardly from the frame and constitute a means for coupling the frame to the side rails of the ladder. These brackets have generally U-shaped sections which extend around the exterior surfaces of the side rails of the ladder. Moreover, the positioning of the brackets relative to one another is adjustable so as to accommodate ladders of differing sizes. Moreover, the relative size of the bracket can be changed for accommodating ladder rails having differing sizes.

As indicated previously, the arms of the frame extend outwardly from the frame. More preferably, they extend rearwardly to engage the generally upwardly presented surface on the building structure. The arms are adjustably positionable laterally relative to the side rails of the ladder in order to adjust the amount of space between each of the arms.

The main frame of the ladder stabilizing apparatus is also pivotal relative to the vertical orientation of the ladder itself such that the main frame can be positioned at an angle relative to a true horizontal position. In this way, the arms can be used to secure the ladder to an eave or a rake of an angulated roof with a position of optimum stabilizing.

In many cases, the roof structure or other upwardly presented surface of the building against which the ladder is used is not truly flat and horizontally disposed. For example, in many roof structures, dormers exist and these dormers have angularly disposed roof walls. However, they have a substantial horizontal component, and to this extent, they are considered generally upwardly presented surfaces. Thus, the roof may have an orientation which is angularly displaced from a vertical plane toward a horizontal plane, i.e., 15° to 45° or more away from a horizonal plane. Accordingly, and in the context of the present invention, a generally upwardly presented surface does not necessarily refer to a roof or other upwardly presented surface which is absolutely horizontal.

The ladder stabilizing apparatus of this invention has, as a principle advantage, the fact that it is actually constructed so as to apply a substantial downward force vector to a building. It is actually this downward force vector which stabilizes the ladder against a sidewards tipping movement, particularly when a sidewards or lateral force is applied to the ladder. One of the serious problems in the use of ladders is that, if weight is not properly distributed on the ladder, it can tend to tip to one side or the other. When a user of the ladder climbs on the ladder, a downward force is literally applied to the roof of the building. This is due to the fact that the roof is frequently canted and the ladder is always located at an angle relative to the building, that is, it is canted relative to the building. Thus, with this substantial vertical force vector, the outwardly extending arms on the stabilizing apparatus engage the roof, and are effectively held against any tipping movement. In other words, if one should attempt to impose a force on one of the lateral sides of the ladder, that force is imposed on the roof's structure, and the ladder will not tip laterally. This is a dramatic and unobvious advantage of the stabilizing apparatus of the present invention.

This invention possesses many other advantages and has other purposes which will be made more fully apparent from a consideration of the forms in which it may be embodied. One of the forms of this apparatus and, for that matter, the associated method, is more fully described in the following description, and more fully illustrated in the accompanying drawings. However, it is to be understood that these drawings and the following detailed description are, set forth for purposes of illustrating and describing the general principles of the invention and are not to be taken in a limiting sense.

### BRIEF DESCRIPTION OF THE DRAWINGS

Having thus described the invention, reference will now be made to the accompanying drawings in which:

FIG. 1 is a perspective view of one embodiment of the ladder stabilizing apparatus constructed in accordance with and embodying the present invention;

FIG. 2 is a vertical sectional view taken along line 2-2 of FIG. 1;

FIG. 3 is a fragmentary perspective view showing a rear side of the ladder stabilizing apparatus of FIG. 1;

FIG. 4 is a perspective view of a slightly modified form of the ladder stabilizing apparatus constructed in accordance with and embodying the present invention;

FIG. 5 is a top plan view of the ladder stabilizing apparatus of FIG. 4;

FIG. 6 is a rear elevational view of the ladder stabilizing apparatus of FIG. 4;

FIG. 7 is a side elevational view of the ladder stabilizing apparatus of FIGS. 4-6;

FIG. 8 is an opposite side elevational view and showing the positioning of a ladder and an individual relative to the ladder using the ladder stabilizing apparatus of the present invention;

FIG. 9 is an enlarged top plan view of one form of ladder stabilizing apparatus constructed in accordance with and embodying the present invention;

FIG. 10 is a side elevational view of the ladder stabilizing apparatus of FIG. 9;

FIG. 11 is a perspective view of a further modified form of ladder stabilizing apparatus constructed in accordance with and embodying the present invention;

FIG. 12 is an end elevational view of the ladder stabilizing apparatus of FIG. 11 showing a folding of one of the arms relative to the frame of the apparatus;

FIG. 13 is an exploded fragmentary perspective view showing the mounting of the arm relative to the frame in the apparatus of FIGS. 11 and 12;

FIG. 14 is a front elevational view of a ladder with the ladder stabilizing apparatus employed relative to the rake of a roof;

FIG. 15 is a fragmentary front elevational view, similar to FIG. 14, and showing a different angulated position of the ladder stabilizing apparatus relative to the rake of the roof and to the ladder; and

FIG. 16 is a perspective view showing the use of the ladder stabilizing apparatus with feet mounted on the ends of the arms thereof.

### DETAILED DESCRIPTION OF PREFERRED EMBODIMENTS

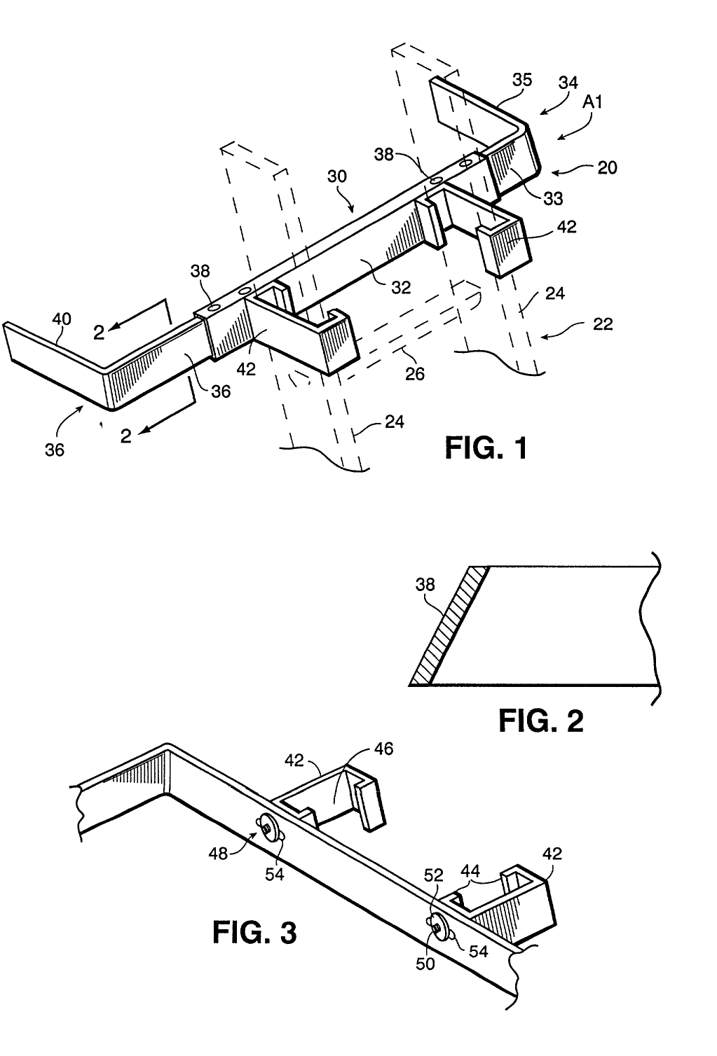

Referring now in more detail and by reference characters to the drawings which illustrate several practical embodiments of the present invention, A₁ designates a ladder stabilizing apparatus, having a main frame 20 which is shown in FIG. 1 as releasibly supporting a ladder 22, the latter of which is shown in phantom lines in FIG. 1.

The ladder with which the ladder stabilizing apparatus A of the present invention will be used generally conventional in construction and comprised of a pair of side rails 24 which are connected by horizontally extending rungs 26 extending therebetween. Some of the ladders with which the invention can be used are the so-called “telescopic” ladders of the type illustrated in FIG. 8, and as hereinafter described. Nevertheless, these telescopic ladder constructions still have a pair of spaced apart side rails connected by rungs.

The main frame 20 of the ladder stabilizing apparatus A₁ is comprised of a first frame section 30 and having an elongate leg 32 and which is generally of tubular construction. Extending outwardly from the right-hand end of the leg 32 is a telescopically adjustable leg 33 forming part of a second frame section 34 and which terminates in an integrally formed perpendicularly arranged, rearwardly struck arm 35 which is adapted to engage a generally upwardly presented surface on a building structure. The main frame 20 also comprises a second leg 36 extending outwardly from the opposite side of the elongate leg 32 and which also forms part of the second frame section 34. In like manner, the leg 36 has a rearwardly struck arm 40 adapted for engagement with a generally upwardly presented surface of a building structure.

Due to the fact that the arms and the legs 33 and 36 are telescopically positionable with respect to the leg 32, the pair of arms 35 and 40 are adjustably positionable relative to one another. Thus, the distance between the two arms 352 leg and 40 can be shortened or lengthened, as desired. Moreover, and by reference to FIG. 2, it can be seen that the legs 33 and 36 and hence the leg 32 is also located at a somewhat acute angle relative to a true perpendicular line. In other words, the legs 33 and 36 are inclined relative to a vertical direction due to the fact that the ladder itself is actually angularly positioned relative to a building structure. The angle of the legs 33 and 36 is approximately the same as the angle of the ladder 22 relative to a wall of a building structure, e.g. 15-18 degrees.

Each of the legs 33 and 36 are telescopically shiftable with respect to the main elongate leg 32 and extend inwardly into the leg 32 when retracted and can be pulled outwardly therefrom, such as to the position as shown in FIG. 1. In this way, a desired distance between the two arms 35 and 40 can be achieved for maximum stabilization, as aforesaid. Furthermore, and in order to hold the pair of legs 33 and 36 in the extended position, the elongate leg 32 may be provided with releasable push button latches 38, as shown in FIG. 1, and which are provided on each of the opposite ends of the leg 32. These push button latches 38 may function such that when depressed, as for example by a thumb, the legs 33 and 38 can be shifted inwardly or outwardly. When released, the legs will lock in a selected position. Otherwise, apertures could be formed in the leg 32 and alignable with like apertures in the legs 33 and 36 for receipt of releasable locking pins or the like.

The ladder stabilizing apparatus A₁ of the present invention also includes a pair of forwardly extended brackets 42. Each of these brackets 42 have a generally U-shaped construction as shown in top plan view and moreover, are provided with reversely bent tabs 44 facing one another as shown in FIG. 3, and thereby provide slots 46 to receive the side rails 24 of the ladder. In this respect, and by reference to FIG. 1, it can be observed that the side rails 24 of the ladder which are generally of a rectangular shape in cross section, will fit within the rectangular recess 48.

The position of the pair of brackets 42, relative to one another can be changed by an adjustable positioning means 50 as best shown in FIG. 3 of the drawings. In this case, the adjustable positioning means 50 comprises bolts 52 having externally threaded sections which extent rearwardly from each of the brackets 42, as shown. Large locking nuts 54 are threaded on these bolts 52 for retentively holding the brackets 42 in a locked position. Moreover, the bolts 52 extend through elongate slots 56 formed in the legs 32 and 38. In this way, the distance between the brackets 42 relative to one another can be either lengthened or shorted, as may be desired. Moreover, this is convenient for purposes of mounting the ladder stabilizing apparatus.

It should be understood that the leg 38 may necessarily be provided with an elongate slot (not shown) but somewhat in alignment with the slot 56 in order to accommodate the bolts 52 if required. Furthermore, and while the adjustable positioning means is shown as including a bolt and locking nut, other forms of adjustable positioning means which would lock the brackets 42 releasibly but in a fixed position could also be employed.

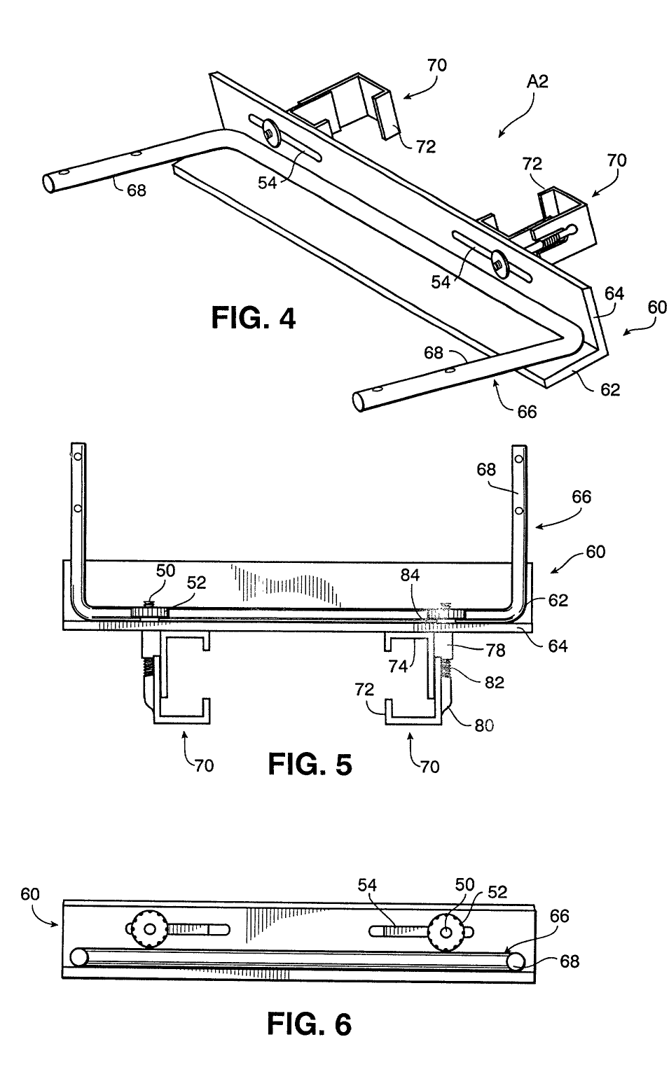

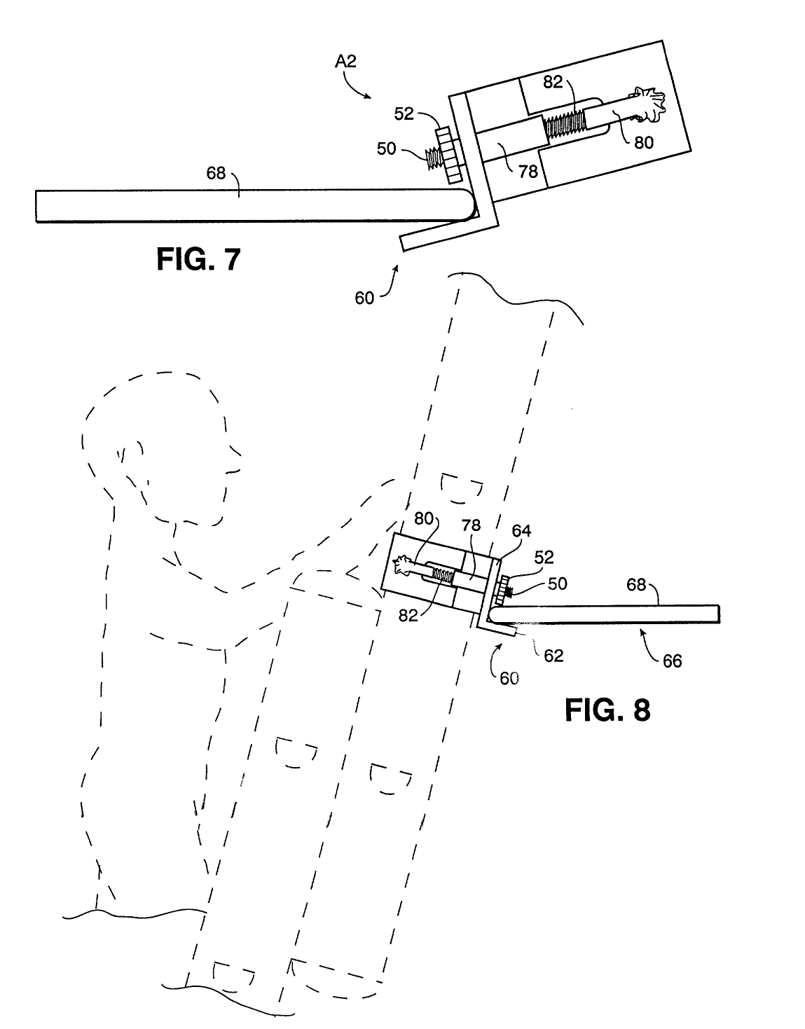

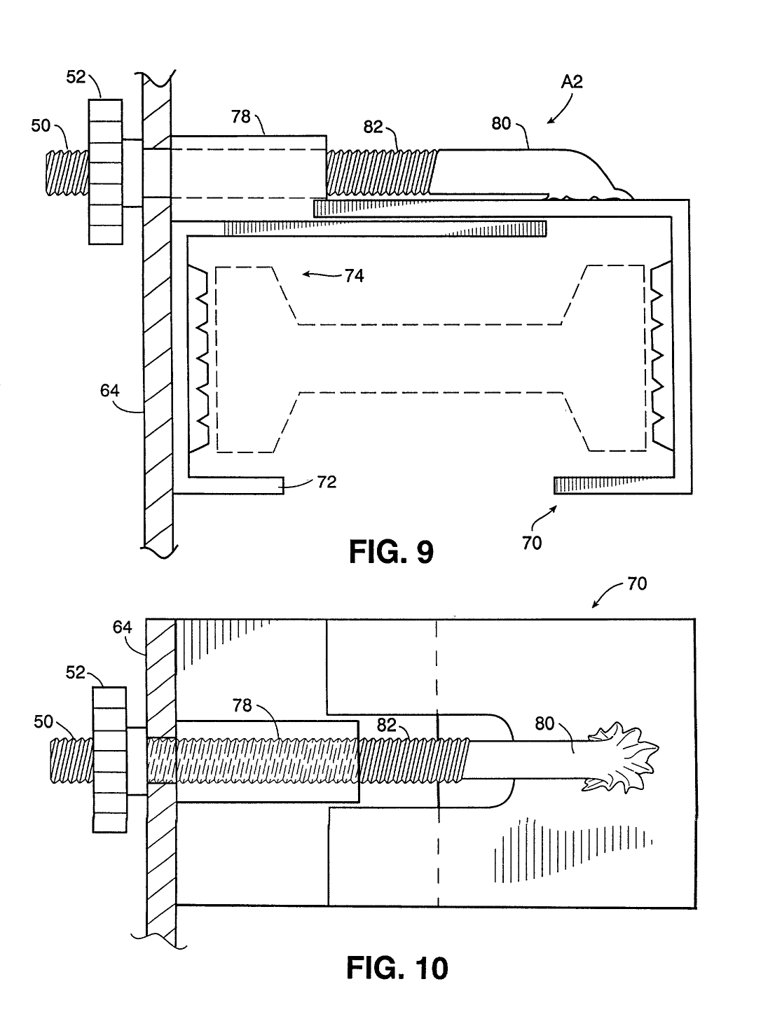

FIGS. 4-10 of the drawings illustrate another modified form of ladder stabilizing apparatus A₂ constructed in accordance with and embodying the present invention. The ladder stabilizing apparatus A₂ comprises a frame 60 which is generally of L-shaped construction, as shown in FIG. 4 and comprises a horizontal leg 62 and a vertically disposed leg 64. In this embodiment, a somewhat U-shaped retainer arm assembly 66 is welded to the L-shaped frame 60 and comprises a pair of laterally spaced apart arms 68, as best shown in FIGS. 4 and 5 of the drawings. In this embodiment, the arms 68 engage the generally upwardly presented surface of the roof or other portion of the building.

The generally U-shaped retainer arm assembly 66 is shown in the embodiment in FIGS. 4-10 as being welded or otherwise rigidly secured to the L-shaped frame 60. However, it should be understood that the U-shaped retainer arm assembly 66 could be secured to the frame 60 in such a manner that it is adjustably positionable at a desired angle relative to the frame 60 in order to accommodate different angles of the generally upwardly presented surface of the roof structure or other portion of a building structure.

The ladder stabilizing apparatus A₂ also has a pair of forwardly extending brackets 70 which are also of a general U-shaped construction, having reversely bent tabs 72 as best shown in FIGS. 4 and 5. In this way, the brackets 70 will accommodate the side rails of a ladder much in the same manner as the brackets 42. The brackets 70, however, unlike the brackets 42, may be adjustable in their longitudinal dimension. The brackets 70 comprise a first bracket section 74 and a second bracket section 76 which are positionable relative to one another. The bracket section 74 is rigidly welded or otherwise rigidly secured to an arm 78 which is in turn secured to the L-shaped frame as hereinafter described. Another arm 80 is threadedly adjustably positionable relative to the arm 78 as shown in FIG. 5 and is also welded or otherwise secured to the bracket section 76, again as best shown in FIGS. 4 and 5 of the drawings. Thus, by rotating a bolt 82 extending between the arms 78 and 80 which are tubular and internally threaded, it is possible to adjustably position the overall dimension between the bracket sections 74 and 76 as well as to adjustably position the overall dimension between each of the brackets 70.

The brackets 70 are also provided with an adjustable positioning means 84 as best shown in FIGS. 5, 7 and 8 of the drawings. The adjustable positioning means is essentially identical to that adjustable positioning means 50 used in the ladder stabilizing apparatus A₁ and is therefore neither illustrated nor described in any further detail in this embodiment.

The ladder stabilizing apparatus A₂ offers the additional advantage that the brackets 70 can accommodate differing sizes of ladder rails. Moreover, it should be understood that the brackets of the ladder stabilizing apparatus A₂ could be used on the ladder stabilizing apparatus A₁.

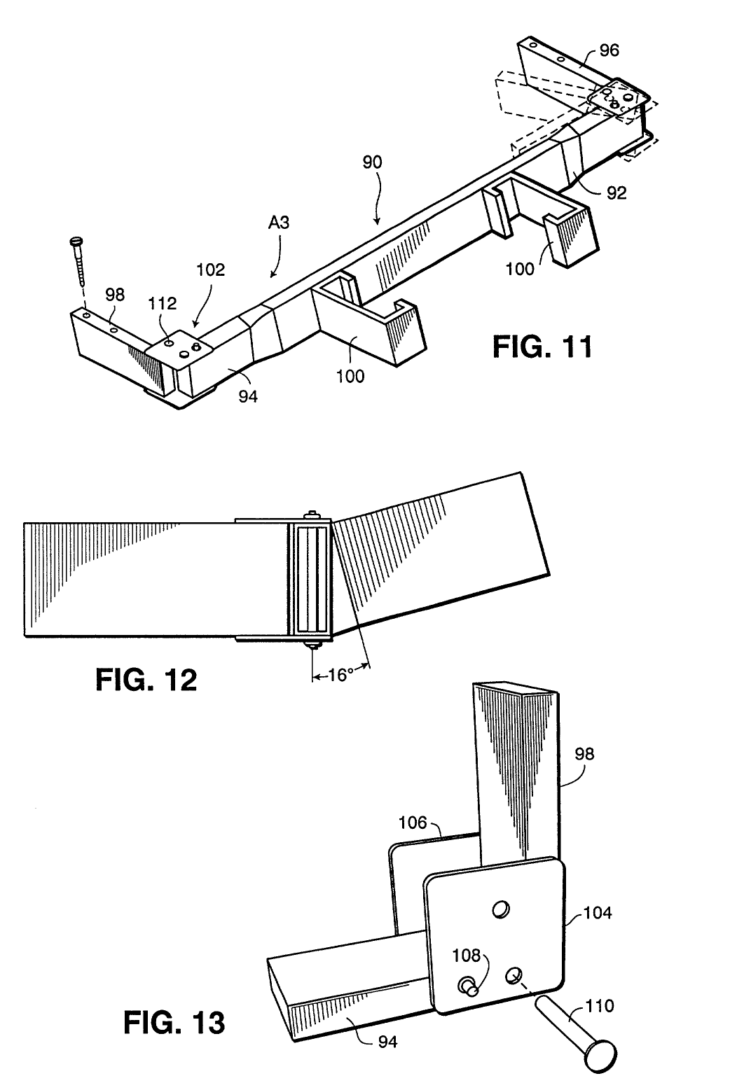

FIGS. 11-13 illustrate a further modified form of ladder stabilizing apparatus A₃. The ladder stabilizing apparatus A₃ also comprises a frame 90 having a first frame leg 92 and a second telescopically located second frame leg 94 which operate much in the same manner as the frame legs 32 and 38. In this respect, arms 96 and 98 are mounted on the ends of the legs in a manner hereinafter described, and can be adjustably positioned at a selective distance therebetween.

Also mounted on the frame leg 92 is a pair of outwardly extending brackets 100 which are substantially identical to the brackets 70 used in the ladder stabilizing apparatus A₂. In this respect, the brackets 100 are also adjustably sizeable in order to accommodate the side rails of a ladder.

The arms 96 and 98 are respectively mounted to the outer ends of the legs 92 and 94, respectively, by a hinge mechanism 102, the details of construction of which is more fully illustrated in FIG. 13 of the drawings. The hinge mechanism 102 comprises a pair of vertically spaced apart hinge plates 104 and 106 with one of the arms, e.g., the arm 98, fitted therebetween, as shown in FIG. 13. The hinge plates 104 and 106 are secured to the outer end of the leg 94 by means of spring pins 108. The arm 98 is pivotally mounted on the end of the leg 94 by means of a rivet-type hinge pin 110. Thus, and in accordance with this construction, it can be seen that the arm 98 can be folded inwardly and lie in juxtaposed relationship to the rearwardly presented face of the leg 94.

When the arm 98 is located in the extended position as shown in FIG. 11, it can be locked in that position by means of an additional locking pin 112 inserted through the hinge plates 104 and 106 and the arm 98.

The arms 96 and 98 can also be provided with vertically arranged screw holes 114 for accommodating wood screws or like screws 116 as shown in FIG. 11. In this way, the ladder stabilizing apparatus could be secured to the roof for a temporary period of time, as for example, when the ladder is used in movie locations and the like.

It should be understood that the arm 96 could be hingedly locked to the leg 92 with the same hinge mechanism 102, as described in connection with the hinged mounting of the arm 98 with respect to the leg 96. Moreover, it can be seen that by use of the hinge mechanism 102, it is possible to fold the arms 96 and 98 in juxtaposed relationship to and against the rearwardly presented surface of the legs 92 and 94, respectively, to thereby provide a small compact unit. Moreover, the brackets 100 can be easily removed from the frame for purposes of storage and/or transport.

One of the important aspects of the present invention is the fact that the angular position of the main frame 32 can be altered relative to the position of the ladder and the position of the roof of the structure against which the ladder is used. As indicated previously, the overall position of the brackets 70 can be adjusted relative to one another due to the fact that the bolts 50 move in elongate slots 54. This mounting of the brackets 70 to the main frame 32, however, also allows the brackets to be pivoted at an angle relative to the main frame. In essentially all cases, the ladder will be positioned in a generally upright orientation with respect to a building. Typically, the ladder is positioned so that it assumes an angle of roughly fifteen degrees to eighteen degrees with respect to a true vertical direction when leaning against a building. More specifically, the ladder is used with a recommended angle of about fifteen to sixteen degrees relative to a vertical direction.

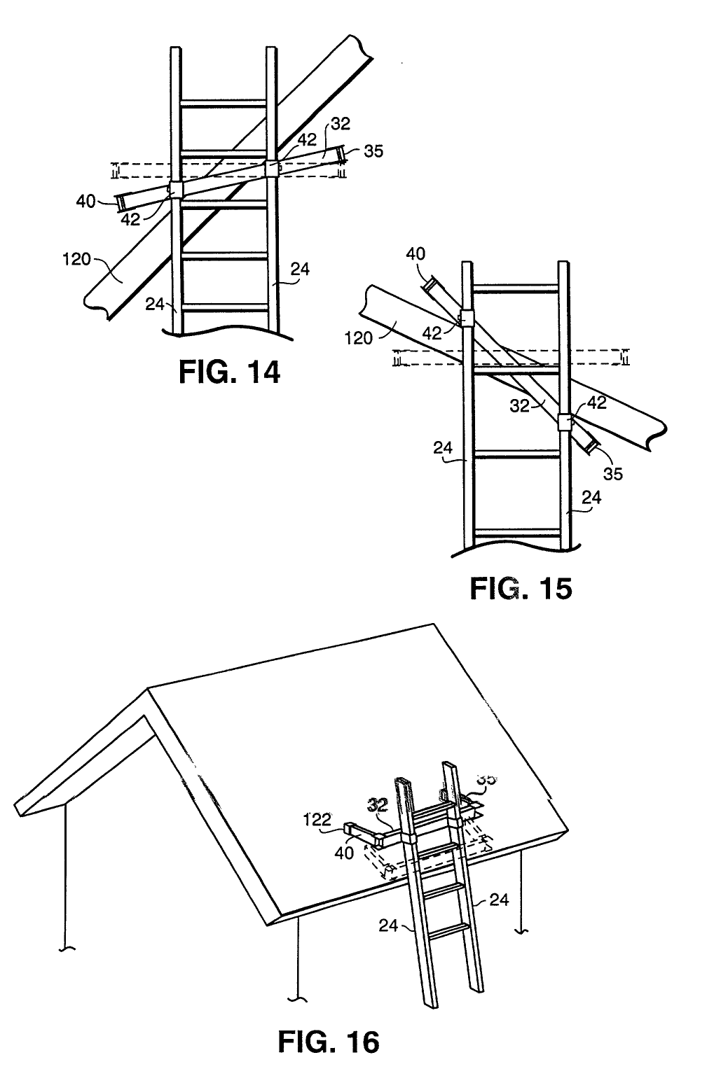

The brackets 70 of the ladder stabilizing apparatus also allow the brackets to be rotated relative to the main frame so that the brackets allow the rails of the ladder to assume a true vertical orientation as shown in FIG. 14. However, this also allows the main frame 32 to be positioned at an angle relative to the rails of the ladder. Thus, and by reference to FIG. 14, it can be observed that one of the arms, such as the left-hand arm 68 is positioned above a rake 120 of a roof and the right-hand arm 68 is located under the rake of the roof. In this way, the left-hand arm 68 precludes the ladder from tipping to the right and the right-hand arm 68 precludes the ladder from tipping to the left. Thus, the ladder will be effectively locked into place on the rake of the roof.

Heretofore, most governmental standards precluded the use of positioning a ladder against the rake of a roof because of the attendant danger of the ladder tipping to one side or the other. The ladder stabilizing apparatus of the present invention overcomes that problem in that the ladder can now be effectively and safely used with the rake of a roof as well as with the eave of a roof.

FIG. 15 is a view similar to FIG. 14 and showing the potential use of the ladder stabilizing apparatus in a different position relative to the rake of the roof and relative to the ladder. This positioning merely shows the universal possibilities of locating the ladder stabilizing apparatus relative to a supporting structure in order to obtain optimum use thereof.

FIG. 16 is a fragmentary perspective view showing the use of the ladder stabilizing apparatus against the eave of a pitched roof and in a position of optimum stabilizing therefore. In this case, it can be seen that the ladder stabilizing apparatus is secured to the ladder in a position such that the arms are generally horizontally disposed.

FIG. 16 also shows in dotted lines a potential position of the ladder stabilizing apparatus where the arms are generally parallel to the pitch of the roof. This ladder position does not necessarily provide any significant stabilization and would normally be avoided. However, when the ladder stabilizing apparatus does assume the position as shown in the solid lines of FIG. 16, full stabilization is achieved. However, in order to prevent any possibility of sliding movement, and further to avoid damage to the roof's structure, rubber feet 122 are mounted on the ends of each of the arms.

The ladder stabilizing apparatus of the present invention is also versatile in its assembly with regard to a conventional ladder. The ladder stabilizing apparatus is adaptable for use with a variety of different sized ladders, including for example, commercial ladders and household use ladders. It can also be mounted when the ladder is already located in a position of use or before the ladder is located in a position of use. Thus, the user of the ladder stabilizing apparatus can position a ladder against a portion of a building and thereafter install the ladder stabilizing apparatus directly on the ladder from the upper end thereof. This ladder stabilizing apparatus is particularly effective with the so-called “extendable ladders”.

Thus, there has been illustrated and described a unique ladder stabilizing apparatus which fulfills all of the objects and advantages which have been sought therefor. It should be understood that many changes, modifications, variations and other uses and applications will become apparent to those skilled in the art after considering this specification and the accompanying drawings. Therefore, any and all such changes, modifications, variations and other uses and applications which do not depart from the spirit and scope of the invention are deemed to be covered by the invention.

Having thus described the invention, what I desire to claim and secure by Letters Patent is:

1 A ladder stabilizing apparatus for holding a ladder in a fixed position against a building with a roof structure and stabilizing the ladder to reduce the possibility of unauthorized tipping laterally to a side or arcuately away from the building, said ladder stabilizing apparatus comprising:
a) a frame;
b) means for releasably coupling said frame to side rails of said ladder to hold said frame to the ladder;
c) a pair of laterally spaced apart arms on said frame adapted to extend outwardly from said frame to engage a roof structure on said building such that a substantial downward force vector is applied to said roof by said spaced-apart arms, thereby stabilizing the ladder against the roof structure of the building; and
d) means for adjustably positioning the arms relative to the ladder to obtain the desire amount of stabilization relative to the building roof structure and the angle of the ladder relative to the building roof structure.

2 The ladder stabilizing apparatus of claim 1 further characterized in that said arms extend rearwardly from said frame relative to the building roof structure to engage a generally upwardly presented surface on the building roof structure.

3 The ladder stabilizing apparatus of claim 2 further characterized in that the downward force vector is applied to the roof structure at the outer ends of the arms and with essentially any horizontal force being applied to the building being no greater than the vertical force vector.

4 The ladder stabilizing apparatus of claim 3 further characterized in that said arms extend rearwardly from said frame relative to the building to engage a pitched roof on the building.

5 The ladder stabilizing apparatus of claim 4 further characterized in that rubber feet are mounted on the ends of the arms for engaging the pitched roof of the building structure.

6 The ladder stabilizing apparatus of claim 3 further characterized in that said frame comprises an elongate bar and the arms extend rearwardly from the bar and are angulated with respect to the plane of the bar so that the arms can extend generally horizontally toward a roof structure and still allow the ladder to be canted with respect to the building.

7 The ladder stabilizing apparatus of claim 6 further characterized in that the frame of the apparatus can also be adjustably mounted relative to the ladder in order to change the angle of the frame relative to the ladder.

8 The ladder stabilizing apparatus of claim 1 further characterized in that said arms are adjustably positionable laterally relative to side rails of the ladder to adjust the amount of space between said arms.

9 The ladder stabilizing apparatus of claim 1 further characterized in that the means for coupling the frame to the side rails of the ladder are a pair of brackets and which are also positionable to accommodate the ladder.

10 The ladder stabilizing apparatus of claim 9 further characterized in that the means of coupling the frame to the side rails of the ladder are a pair of brackets and which are also positionable laterally to accommodate the ladder.

11 The ladder stabilizing apparatus of claim 1 further characterized in that the arms are hingedly mounted with respect to the frame and can be folded up against the frame for storage and/or transport.

12 The ladder stabilizing apparatus of claim 9 further characterized in that the brackets are each sizeable so as to accommodate ladder rails of differing size.

13 The ladder stabilizing apparatus of claim 9 further characterized in that the brackets are of a fixed dimension to accommodate selectively sized ladder rails.

14 A ladder stabilizing apparatus for stabilizing a ladder having a pair of laterally spaced apart side rails connected by vertically spaced apart rungs against lateral tipping or arcuately shifting with respect to a building with a roof structure having an orientation which is angularly displaced from a vertical plane toward a horizontal plane, said ladder stabilizing apparatus comprising:
a) a frame comprised of a pair of adjustably positionable legs so that one leg may be extended relative to the other and where the legs have a vertical dimension which is generally parallel to the ladder when the ladder is leaned against a vertical wall of a building at an angle to the vertical wall;
b) a pair of arms extending outwardly from said legs for engaging a generally upwardly presented surface of a roof structure on said building such that a substantial downward force vector is applied to said roof by said spaced-apart arms thereby stabilizing the ladder against the roof structure of the building, said arms being mounted on said legs at an angle to the vertical dimension of the legs so that the arms are approximately horizontally disposed when the ladder is leaning against a vertical wall of a building at an orientation angularly displaced away from a vertical plane;
c) bracket means extending outwardly from said frame in a direction opposite to said last named means for engaging and retentively but nevertheless releasably holding the spaced apart side rails of the ladder; and
d) size adjustable means associated with each of said bracket means for adjusting the overall size of each of said bracket means to accommodate a particular size of a ladder's side rails.

15 The ladder stabilizing apparatus of claim 14 further characterized in that the means extending outwardly from the frame to engage a generally upwardly presented surface constitutes a pair of spaced apart arms.

16 The ladder stabilizing apparatus of claim 14 further characterized in that the means for adjustably positioning the size of the bracket means comprises bolts extending from said bracket means and through said frame and retentively held by means of nuts.

17 The ladder stabilizing apparatus of claim 15 further characterized in that the arms are positionable by a distance which can vary between each of the arms on said frame.

18 The ladder stabilizing apparatus of claim 17 further characterized in that the arms on each of said legs are integral with said legs.

19 The ladder stabilizing apparatus of claim 14 further characterized in that a downward force vector is applied to the roof structure at the outer ends of the arms and with essentially any horizontal force being applied to the building being no greater than the vertical force vector.

20 A method of stabilizing a ladder in a fixed position against a building having a roof structure to reduce the possibility of unauthorized tipping laterally to a side or arcuately away from the building, said ladder stabilizing method comprising:
a) securing a stabilizing frame to the generally upright rails of a ladder;
b) leading a ladder against the building with respect to a vertical wall of the building unit without engaging the vertical wall;
c) locating a pair of laterally spaced apart outwardly extending arms on said frame to engage a partially upwardly presented surface of the roof structure of the building; and
d) allowing the arms to apply a substantial downward force component to the partially upwardly presented surface when the ladder is leaned toward the building at an angle with respect to a vertical plane.

21 The ladder stabilizing method of claim 20 further characterized in that the downward force vector is applied to the roof structure at the outer ends of the arms and with essentially any horizontal force being applied to the building being no greater than the vertical force vector.
